(19) United States
(12) Patent Application Publication
(10) Pub. No.: US 2016/0194146 A1
(43) Pub. Date: Jul. 7, 2016

(54) DISPOSABLE CAPSULE AND METHOD FOR PRODUCING A DOSE OF A DRINK IN AN AUTOMATIC DRINKS MACHINE

(71) Applicant: PRO AQUA DIAMANTELEKTRODEN PRODUKTION GMBH & CO KG, Niklasdorf (AT)

(72) Inventors: Michael SCHELCH, Oberaich (AT); Wolfgang STABER, Bruck an der Mur (AT); Robert HERMANN, Oberaich (AT); Wolfgang WESNER, Wien (AT)

(21) Appl. No.: 14/915,819

(22) PCT Filed: Aug. 25, 2014
(86) PCT No.: PCT/EP2014/067992

§ 371 Date: Mar. 1, 2016

(30) Foreign Application Priority Data
Sep. 2, 2013 (AT) A50539/2013 2.

(51) Int. Cl. B65D 85/804; A47J 31/40

(52) U.S. Cl. CPC B65D 85/8043; A47J 31/407

(57) ABSTRACT

A disposable capsule for preparing a serving of a drink in a drinks machine includes a first capsule part which has a first container that is configured to contain a liquid, such as water. The disposable capsule further includes a second capsule part including a second container that contains a medium to be extracted. The two containers are separated from each other by a rising membrane which is under pressure. The first container is designed in such a way that its volume is reducible under external pressure.

The invention described herein relates to a disposable capsule for preparing a dose of a drink in an automatic drinks machine, having a capsule part, comprising a container with the liquid, in particular water, and having a capsule part, comprising a container with the extracted medium, e.g. coffee or tea, wherein the two containers are separated from each other by a membrane that rises under pressure. The invention further relates to a method for preparing a dose of a drink in a drinks machine using a disposable capsule with a container with the liquid and a container with the medium to be extracted, such as tea or coffee, wherein the containers are separated from each other by a membrane that is broken open under pressure.

Such a capsule and such a method are known for example from DE 2 004 760 A1. The membrane, built-in between the two capsule parts, is broken open by the resulting overpressure in the container, once the water is heated in the upper capsule part to approximately 103° C., leaving a circular opening which allows the passage of the heated water. The heated water flows through the coffee in the lower part of the capsule and finally seeps into a collecting chamber, the bottom of which is also opened by the pressure acting upon it. The heating is maintained so that a corresponding pressure in the upper part of the capsule remains, which is sufficient to practically remove all the water there from. With this known capsule, the water therefore has to be heated to a temperature beyond the boiling point as the vapor pressure is used to push the water through the container filled with coffee or tea. The heating must then be maintained as long as there is water in the tank.

The invention has the underlying task to provide a disposable capsule and make available a method of the aforementioned type with which a hot or cold drink can be produced in a simpler manner.

The set task is achieved according to the invention, in that the container with the liquid is designed in such a way that its volume can be reduced under external pressure.

As far as the method is concerned, the set task is accordingly achieved according to the invention, in that, the volume of liquid is reduced by the reduction of the volume of the container with the liquid, whereby the liquid is pressed from the container with the liquid, in and through the container containing the medium for extracting.

With the invention, the volume of the liquid in the liquid container of the capsule is reduced by external pressure, so that, the liquid is pressed through the container with the medium for extracting. If a hot drink is to be prepared, the liquid therefore only needs to be initially heated. A correspondingly higher pressure may be further exerted to obtain an optimum pressure flow on to the medium to be extracted and a very good extraction effect can be achieved.

In a preferred embodiment of the invention, the container with the liquid has a bellows-like collapsible coat. The container can therefore be deformed by external pressure and the liquid is pressed out of the container through the extracting medium. This embodiment has a simple structure and the further advantage is that the used disposable capsule has a particularly small volume.

In an alternative embodiment, the container with the liquid has a lid which is sealed to the interior of the container and which is moveable in the direction of the container base. In this embodiment, the container volume is reduced by external pressure on the lid and so the liquid is then pressed through the medium to be extracted.

In a particularly preferred embodiment, the two containers are cylindrically designed and aligned coaxially with each other. Such an executed disposable capsule has a particularly small space requirement and the pressure ratio during the application of external pressure is particularly favorable.

For a good extraction efficiency, a further advantage is, if the container with the medium to be extracted has a cross sectional area which is substantially less, in particular a fifth up to a tenth, of the greatest cross sectional area of the container receiving the liquid. It is also more favorable for extraction efficiency if the extension of the container with the medium to be extracted is substantially larger in the flow direction than its largest diameter.

For the preparation of hot drinks, the disposable capsule should be made out of a temperature-resistant material, whereby it is advantageous if at least the outer components of the disposable capsule are made from aluminum sheet. In one embodiment of the container containing the liquid with a bellows-like collapsible coat, aluminum plate is particularly well suited.

Furthermore, the disposable capsule may contain an extraction medium such as coffee, tea, cocoa, chocolate or soup each in its corresponding form. As a liquid, the disposable capsule contains water that is tailored to each drink with respect to its composition in order to produce, for example, taste-perfect tea or coffee. Water contained in the disposable capsule can be further provided with additives for influencing the taste, the aroma or appearance of the product to be consumed.

Furthermore, the water can contain solubilizers such as cow's milk, soy milk or alcohol products. By these additions, special touches of flavor can be added to the drink produced.

For the preparation of a hot drink, the liquid is first heated, by the process according to the invention, to a temperature preferably the below boiling point and is in particular about 85° C. With the process according to the invention, it is therefore not necessary to heat the liquid or the water in the disposable capsule to a temperature beyond the boiling point since the heated water is pressed through the medium to be extracted by external pressure.

With the method according to the invention, moreover, the extraction conditions can be optimally adjusted to the respective medium to be extracted, in particular, when special extraction programs are used, for example, the rate of extraction, the liquid or the extraction temperature and/or the pressure at which the liquid is forced through the medium to be extracted, can be programmed, selected or regulated according to preferences.

The invention further relates to a drinks machine for preparing a portion of a drink using a disposable capsule according to the invention. The drinks machine according to the invention comprises a capsule holder, which can be locked into the drinks machines, but otherwise is a separable part from the drinks machines and has a handle and a capsule holder. For the preparation of hot beverages, heaters are installed in the capsule, which are electrically contactable when locking the capsule handle in the drinks machines.

A drinks machine according to the invention further includes an electrically, hydraulically or manually operated plunger or similar that applies the pressure on the disposable capsule.

Further features, advantages and details of the invention will now be explained in more detail using drawings that illustrate the embodiments schematically. The following;

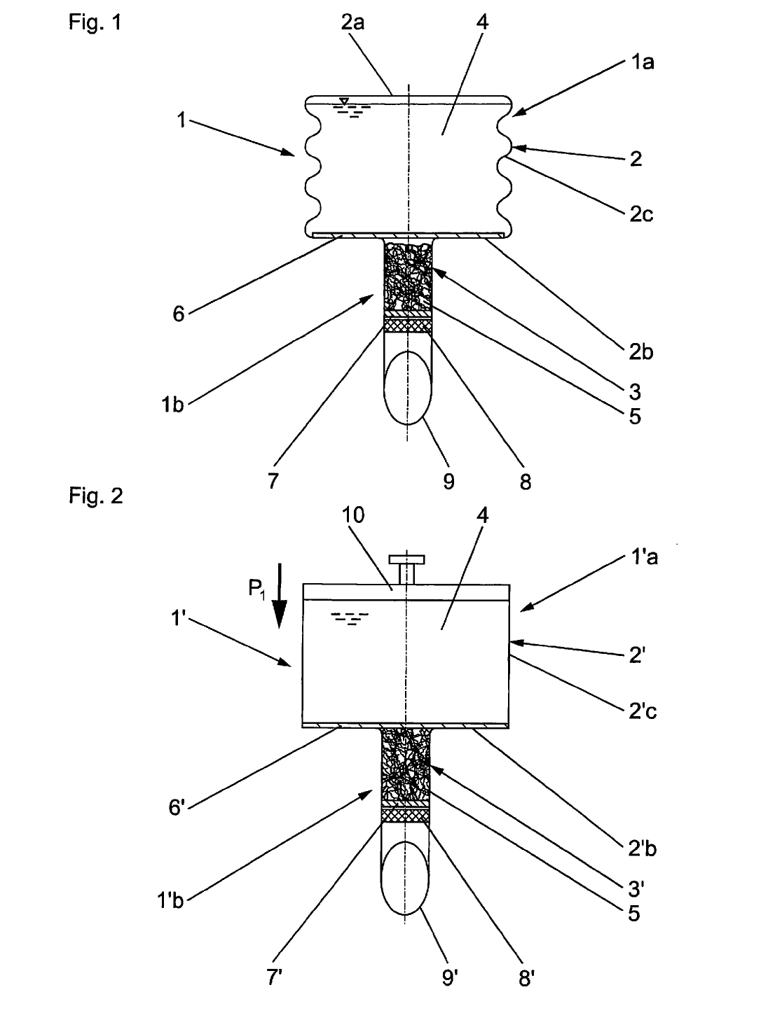

FIG. 1 a sectional view of an embodiment of a disposable capsule according to the invention,

FIG. 2 a further embodiment of a disposable capsule according to the invention in a sectional view,

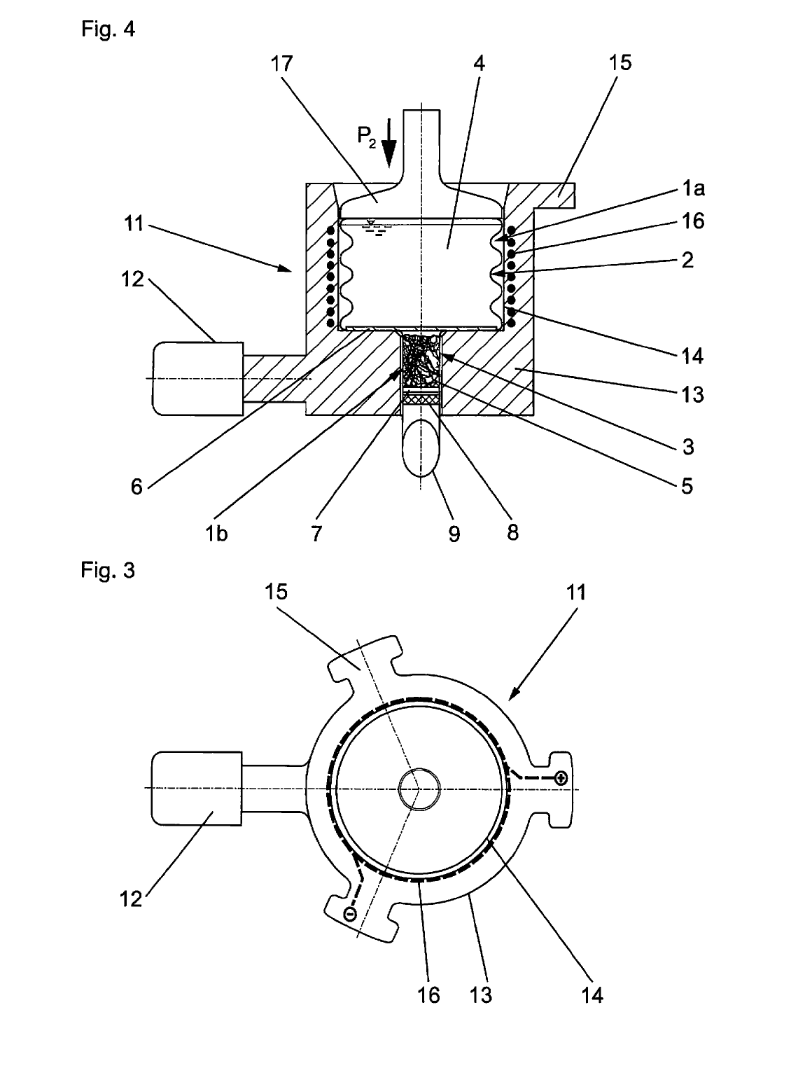

FIG. 3 a capsule holder according to the invention for inserting a disposable capsule according to the invention into a drinks machine, such as an espresso machine, for producing a drink and,

FIG. 4 a sectional view of a capsule holder positioned in a drinks machine.

In the following description, terms such as “top”, “above”, “below”, “lower” and the like relate to the illustrations. The use of the illustrated parts may deviate.

FIG. 1 shows the principles of an embodiment of a disposable capsule 1 according to the invention for producing a drink, such as coffee or tea, cocoa, chocolate, soup or similar in a drinks vending machine or a so-called capsule applicator. The capsule 1 consists of an upper enclosure part 1a and a lower capsule part 1b which are interconnected. The upper enclosure portion 1a has a container 2 which is filled with liquid; the lower part of the capsule 1b comprises a container 3 containing the medium to be extracted 5 in the amount sufficient for one serving of a drink. Tea comes preferably as dried, crushed tea leaves, coffee in powder form. The liquid in container 2 is preferably water, for example, soft, low mineral content and oxygen-rich water. The container 2, filled with the liquid 4, has a substantially larger volume and a substantially larger diameter than the container 3 containing the medium to be extracted 5. Regarding the embodiments illustrated in the figures, the upper capsule part 1a is made up of the container 2. The containers 2, 3 are preferably cylindrical shaped and coaxially arranged. The container 3 with the medium 5 has a cross sectional area that is one fifth to one tenth of the maximum cross-sectional area of the container 2 receiving the liquid 4. In a further embodiment not shown, the lower capsule part of the capsule is truncated cone-shaped and is not dethatched from the upper capsule part, the pointed side is the free side. The upper part of the capsule may have a cylindrical shape, adjusted from the diameter of the broad side of the truncated cone or also in particular, only a slightly truncated cone shape.

The container 2 has in particular a volume of 15 ml to 150 ml, container 3 in particular, a volume of 3 ml to 30 ml. The two capsule parts 1a, 1b may be made of a thin aluminum sheet or a material of similar properties. The upper capsule part 1a has a lid 2a, a base 2b and a coat 2c. The base 2b has an opening centrally to the container 3, which is covered with a membrane 6, which can completely cover the bottom 2b. The coat 2c is a bellows-like design that is collapsible or foldable, so that, during the production of the drink, as will be described later, the lid 2a can be moved almost to the base 2b under the external action of pressure.

The container 3 containing the medium to be extracted 5, with the embodiment shown, is an elongated cylinder and restricted from below by a second membrane 7, on which a sieve 8 is directly attached. The membranes 6 and 7, therefore, close the top and bottom of the container 3. The lower capsule part 1b is extended above the container 3 and also forms a pouring element 9 for the produced drink. The two membranes 6, 7 consist of a liquid-tight material, which breaks at a pressure greater than 10 bar. The sieve 8 is such a fine mesh that it only allows liquid, but no medium 5 to escape from the container 3 with an open membrane 7. The sieve 8 may be further provided additionally with small protrusions on its side facing the membrane 5, that serve as puncture tools and that can penetrate the membrane. The part comprising the pouring element 9 is further designed such that the sieve 8 remains fixed.

Another embodiment of a capsule 1′ is shown in FIG. 2. The lower capsule part 1′b of the capsule 1′ corresponds to the lower capsule part 1b of the capsule 1 that is shown in FIG. 1, and therefore comprises a container 3′, a pouring element 9′, a membrane 7′ and a sieve 8′. The container 2′ that receives the liquid 4 in the upper capsule part 1′a is designed analogous to the embodiment shown in FIG. 1 preferably cylindrical and has a base 2′b and a smooth coat 2′c. Instead of a fixed lid, the container has a plunger 10 which is sealed against the coat 2′c, but which is movable by external pressure from above in the direction of the arrow P1 in FIG. 2 toward the base 2′b.

In both embodiments, the heated liquid 4 located in the container 2, 2′, for example, is pressed through the medium 5 in the reservoir 3, 3′, by the embodiment shown in FIG. 1 by exerting pressure on the lid 2c, and the subsequent folding of the coat 2c, by the embodiment shown in FIG. 2 by a moving of the plunger 10 towards the ground 2′c. As mentioned above, the applied pressure causes a breaking of the two membranes 6, 7. The resistance with which the medium 5 meets the liquid in the container 3, 3′ increases the pressure in the container 3, 3′, so the liquid flows through the medium 5 very well and the medium is extracted.

FIG. 3 and FIG. 4 show a possible embodiment of the components of a drinks machine working together with a capsule 1 according to the invention, of which further, conventionally executable components in particular are not shown. FIG. 3 shows an embodiment of a capsule holder 11 that has a handle 12 and a capsule holder 13. The capsule holder 13 has a continuous and complete opening 14 carried out in stages, in section (FIG. 4), in the center, into which the two capsule parts 1a, 1b and 1′a, 1′b of the capsule 1, 1′ can be used and are intrinsically precisely fitting. At the periphery of the capsule holder 13, several locking elements 15, for example, locking tabs, may be provided, so that the capsule holder 11 are inserted into the drinks machine in a known manner and can be locked in by twisting.

In the capsule holder 13, heating elements 16, particularly heating wires or similar are installed, which can be automatically electrically contacted with the proper locking of the capsule holder 11 into the drinks machine in a manner not shown. For example, by operating a switch, not shown, in the drinks machine, the heating elements 16 are supplied with electric current and in such a way heat the liquid or rather water 4 in the container 2 by the contact between the capsule holder 13 and the upper capsule part 1a or container 3 respectively. As soon as the liquid 4, for example, is heated to about 85° C., a plunger 17 exerts a pressure on the lid 2a from the outside and compresses the container 3, so that the pressurized liquid first breaks open the membrane 6, and then the membrane 7. With the progressive reduction of the liquid volume in the container 2, more and more liquid is pressed through the medium 5 in the container 3.

The plunger 17 exerting pressure on the lid 2a of the container 2 can be operated electrically or hydraulically. Alternatively, the actuation of the plunger 17 can be carried out also by a lever attached to the drinks machine by hand with muscle power. Once the drink serving is finished, the plunger 17 is moved upwards, the capsule holder 11 on the handle 12 is gripped, unlocked by turning and removed from the drinks machine. The used capsule 1 can be removed from the capsule holder 11 by simply tilting or turning. The same capsule holder 11 can be used for the capsule shown in FIG. 2. In this embodiment, the plunger 17 moves the punch 10 along the container jacket 2′c to the base 2′b.

It is advantageous to provide special extraction programs in the drinks machines for different media to be extracted 5. Such programs allows the regulation, for example, of the speed at which the volume of the fluid in the container 2, 2′ is reduced, and even independently of the temperature of the fluid 4. Extraction programs can optimally adapt the extraction parameters such as pressure, temperature and extraction time on the respective medium to be extracted 5. Naturally, it is also possible to provide a manual adjustment of these parameters.

Special extraction programs especially allow the selection of optimum extraction conditions. For specific media to be extracted it is, for example, advantageous if, in a first step, a humidification of the medium takes place at a moderate temperature without an extract being prepared at this point. While the medium to be extracted 5 initially still contains many extractible substances, their concentration decreases during the extraction process. To completely use as much as possible the medium to be extracted without diluting the extract formed, it is advantageous to increase the pressure and/or temperature or to reduce additionally or alternatively, the extraction rate near the end of the extraction. This enables the production of high-quality extracted drinks while only using a small amount of the extracting medium. Furthermore, it is not desirable, not only for tea, but also with some coffee varieties, to extract all the substances contained, because with too high concentrations or prolonged extraction processes, unwanted bitter substances get into the solution. It is known, for example, that after twenty to thirty seconds of infusion green tea develops its optimum flavor, while many low-tannin black tea varieties need five to six minutes to develop the full flavor. Some tea varieties, such as Pu-erh Tea, are, with extraction times more than thirty seconds, practically undrinkable.

In summary, therefore, it can be established that there are optimum extraction conditions for each medium to be extracted 5 or for any desired medium composition which can be developed experimentally, if it is possible to adjust the various extraction parameters independently from each other. This possibility is opened in the present invention, in particular by the use of special extraction programs.

The particular advantage of the present invention is also that the liquid 4, which is required for extraction and thus for the preparation of drinks, is supplied already in a container 2, 2′. This measure allows the adjustment of the liquid 4 to the medium to be extracted 5 and in addition, the taste of the drinks produced are influenced and improved by changing the settings and/or optimization of the liquid 4. So it is known, for example, that hard water is more suitable to produce tannin tea, while only very soft water should be used for the production low-tannin teas.

Through the provision of the liquid 4, a further independence from the available tap water is achieved, so the water does not need to be topped up, there is no water supply required and it eliminates the need of the drinks machines to be decalcified. Of particular advantage is the fact that because of this, an independent and reproducible quality of the drinks produced can be assured. This also ensures a bacteriological and chemical integrity of the drinks, which can be an essential aspect against the backdrop of dwindling water reserves, questionable water treatment and contamination of drinking water, not least after an accident, technical malfunctions or in crisis areas.

As the liquid 4 or rather the extraction medium and the basis for the drinks, water that ensures the high-quality and optimal taste comes into question in the first instances. The water can be processed in order to adjust certain properties, such as hardness, salinity, pH and the like. Furthermore, various additives can be admixed in the water, for targeted influences of the taste of the drink, its aroma or its appearance, whereby permitted food additives, further extracts of natural products and similar preferably come into question. In order to optimize the extraction of the water solubilizing agents may be added. As solubilizers, for example, milk and/or products derived from milk and soy are also suitable. Alcohols as solubilizers also improve the extraction. In addition, alcoholic hot drinks can be generated, such as tea with rum, various alcoholic coffee and cocoa specialties and also mulled wine or punch.

With the use of a suitable extraction agent in combination with the possibility to carry out the extraction at any temperature, products such as iced tea, iced coffee, etc. can be produced using suitable instruments.

### REFERENCE NUMERAL LIST

1, 1′ Capsule

1a, 1′a Upper capsule part

1b, 1′b Upper capsule part

2, 2′ Container

2a Lid

2b, 2′b Base

2c, 2′c Coat

3, 3′ Container

4 Liquid

5 Coffee/Tea

6, 6′ Membrane

7, 7′ Membrane

8, 8′ Sieve

9, 9′ Pouring element

10 Punch

11 Capsule holder

12 Handle

13 Capsule holder

14 Opening

15 Regulating valve element

16 Heating element

17 Plunger

P1 Arrow

P2 Arrow

1. A disposable capsule for producing a serving of a drink in a drinks machine, comprising:
a first capsule part, which has a first container, configured to contain water, and
a second capsule part, which has a second container configured to contain a medium to be extracted, wherein:
the first container and the second container are separated from each other by a membrane that rises under pressure, characterized by the fact, and
the first container is configured such that its volume is lastingly reducible under external pressure.

2. The disposable capsule according to claim 1, wherein the first container has a bellows-shaped coat and is therefore compressible.

3. The disposable capsule according to claim 1, wherein the first container has a lid sealed to an interior of the first container, the lid being movable in the direction of a base of the first container.

4. The disposable capsule according to claim 1, wherein the first container and the second container are cylindrical and coaxially arranged with each other.

5. The disposable capsule according to claim 1, wherein at least the second capsule is truncated cone-shaped, whereby with a pointed side of the truncated cone is a free side thereof.

6. The disposable capsule according to claim 1, wherein the second container has a cross sectional area that is a fifth to a tenth of the maximum cross-sectional area of the first container.

7. The disposable capsule according to claim 1, wherein the extension of the second container in a flow direction is substantially greater than its largest diameter.

8. The disposable capsule according to claim 1, wherein the second container is closed at an end thereof that faces away from the first container, with a further rupturable membrane.

9. (canceled)

10. The disposable capsule according to claim 1, wherein the second container contains, as the medium to be extracted, coffee, tea, cocoa, chocolate or soup, in extractable form.

11. The disposable capsule according to claim 1, wherein the second container contains the water, which includes at least one of:
additives to influence the taste, aroma or appearance of drinks produced by the drinks machine; and
a solubilizer selected from at least one of cow's milk, soy milk products and alcohol.

12. (canceled)

13. A process for preparing a serving of a drink in a drinks machine using a disposable capsule with a first container that contains water and a second container containing a medium to be extracted (5), the first container and the second container being separated from each other by a membrane that breaks open under pressure, the method comprising:
decreasing the volume of the water by reducing the volume of the first container, whereby the water is pressed out of the first container into and through the second container and, under external pressure, the volume of the first container is lastingly reduced.

14. The method according to claim 13, further comprising:
for the preparation of a hot drink, first heating the water to a temperature below boiling point.

15. The method according to claim 13, wherein the volume of the first container is reduced by the application of an external pressure.

16. The method according to claim 13, wherein an extraction speed by which the medium is extracted is selectable or adjustable.

17. The method according to claim 13, wherein a temperature of the water or the extracted medium is selectable or adjustable.

18. The method according to claim 13, wherein pressure used to reduce the volume of the first container is selectable or adjustable.

19. (canceled)

20. A drinks machine for producing a serving of a drink, comprising:
the disposable capsule according to claim 1, and
a capsule holder, which is capable of being locked into a body of the drinks machine, is a separable part and includes:
a handle, and
a structure adapted for holding at least one of the first capsule and the second capsule.

21. The drinks machine according to claim 20, wherein the capsule holder contains at least one heating element.

22. The drinks machine according to claim 21, wherein the at least one heating element can be electrically contacted.

23. The drinks machine according to claim 20, further comprising an electrically, hydraulically or manually actuatable plunger that applies pressure to the disposable capsule.
